(19) United States
(12) Patent Application Publication
(10) Pub. No.: US 2006/0147605 A1
(43) Pub. Date: Jul. 6, 2006

(54) Method and manufacturing process for making tomato-based products

(76) Inventor: Jean Maurice Deneve, Dakota Dunes, SD (US)

Correspondence Address: Tony Olson, Suite 151, 801 River Drive, North Sioux City, SD, 57049, US

(21) Appl. No.: 11/029,575

(22) Filed: Jan. 4, 2005

(51) Int. Cl. A23L 1/212

(52) U.S. Cl. 426/615; 426/643

(57) ABSTRACT

A method of the preparation of a tomato-based product containing protein is described, including combining a first set if ingredients such as onion and oil into a mixture, cooking the mixture adding a additional ingredients to the mixture whereas said ingredients include tomato-based ingredients and an effective amount of cultured dextrose and possibly water, continuing to cook the mixture, possibly at a temperature of 160 to 170 Fahrenheit, combining a third set of ingredients into the mixture including a protein, possibly a sea food such as tuna, further cooking the mixture, perhaps at a temperature of around 170 Fahrenheit for around 5 to 7 minutes, raising the temperature of the mixture to around 195 degrees Fahrenheit and maintaining that temperature for around 15 minutes, placing said mixture in containers such as jars and finally sealing the jars.

### FIELD OF THE INVENTION

The present invention generally relates to the field of making tomato-based products for storage in jars.

### BACKGROUND OF THE INVENTION

Making or manufacturing tomato-based sauces or spreads that contain protein for distribution in jars is a difficult process. These sauces might be a pasta sauce, a pizza topping, a salad topping, appetizers, spreads and salsa. Cooking and heat processing must be controlled to properly cook the ingredients, producing the desired flavor, while also reducing bacteria to allow room-temperature preservation of the finished product for reasonable periods of time. The complexity increases when adding protein to the sauce or spread. The protein increases potential for the growth of bacteria, thereby reducing the shelf life of the finished product. Previously, treating the protein with an acidic mixture, possibly citric acid or lactic acid, before adding the protein to the product reduced the overall PH of the product to a level that retarded bacterial growth enough to provide adequate shelf life, but with limitations and a potential effect on taste. The end product may inherit the acidic taste changing the desired product. Furthermore, this process has only been shown to be effective at protein content levels of around 3% or less, preventing products from having a greater percentage of protein content. Therefore, tomato-based sauces in jars have been somewhat limited to around 3% or less content of fish or meat.

Adding to the difficulty in manufacturing tomato-based sauces with protein that may be preserved for long periods of time at room temperatures, some manufactures want to provide products comprising “Natural” ingredients. This not only provides a better product, perhaps tasting better or being more healthy, but some customers may look for the words, “All Natural,” “Natural,” or “Made from Natural Ingredients” on the label. Therefore, in order to be able to claim “Natural,” the ingredients should not include artificial components such as colorings, additives and preservatives. Therefore, for a natural product, certain preservatives should not be included.

An alternative would be to use a high-heat process, such as retorting that might be used to can tuna. In this process, practically all bacteria is killed by exposing the product that is already sealed in a container to temperatures around 250 degrees Fahrenheit for around 12 minutes while maintaining pressure on the container so it doesn't explode. This process works well for pure protein products, such as canned tuna, which cooks well at the high temperatures, proving to yield a product that has been shown to be safe when stored for up to 5-7 years at room temperature. Unfortunately, this process does not work well for tomato-based products because the resulting sauce will not only lose flavor but also will turn brown and be unattractive.

Therefore, a method and manufacturing process for tomato-based sauces containing protein is needed.

### SUMMARY OF THE INVENTION

Accordingly, the present invention is directed to a method of producing sauces or spreads that are tomato-based, contain protein and can be stored at room temperature for long periods of time.

In one aspect of the present invention, a tomato-based sauce or spread containing a protein is prepared for sealing in jars. The process is similar to the home canning process but modified to preserve flavor when manufacturing large quantities of a sauce or spread. During the cooking process, cultured dextrose is added to the mixture to lower the Ph to a level that will help preserve the sauce or spread after sealing the sauce or spread in a jar.

In another aspect of the present invention, the protein is a seafood such as shrimp, tuna or clam and the amount of seafood is greater than 3 percent, while the amount of tomato-based ingredients is over twenty percent, perhaps approximately 49 percent by weight.

In another aspect of the present invention, the ingredients are substantially natural permitting the manufacture to mark the label with the words “All Natural.”

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow chart of the present invention.

### DETAILED DESCRIPTION OF THE INVENTION

Reference will now be made in detail to the presently preferred embodiments of the invention, examples of which are illustrated in the accompanying drawings.

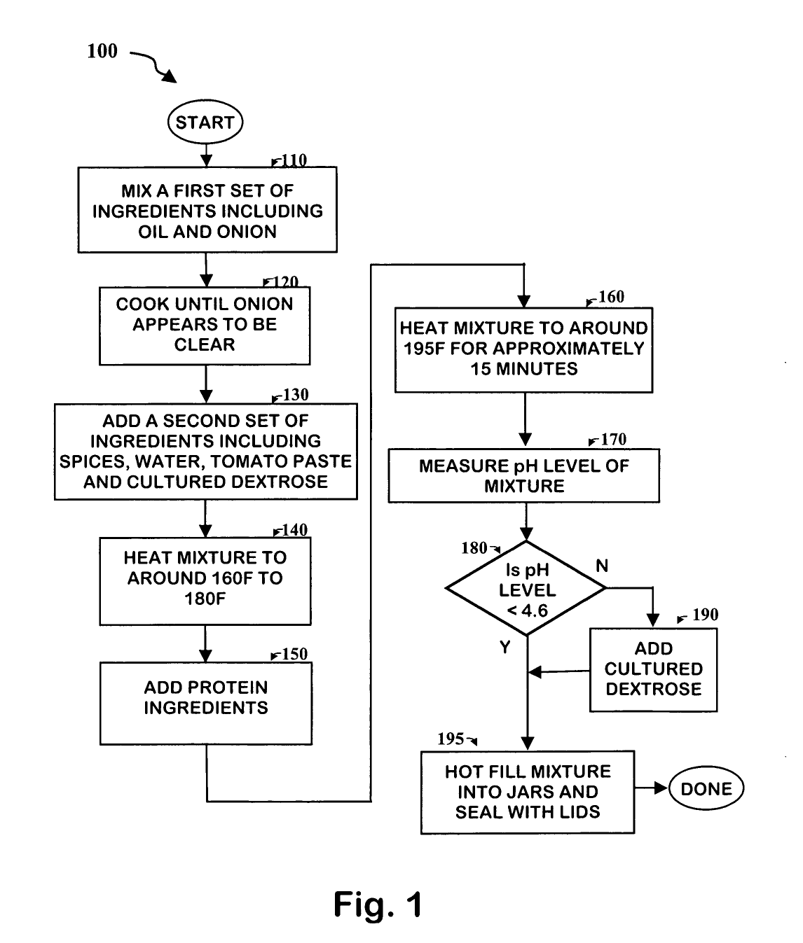

Referring generally now to FIG. 1, a flow chart of a typical cooking process for a sauce or spread is shown. The sauce or spread is a tomato-based sauce that includes protein. The protein may be a seafood, a meat or a soy-based protein. Seafood such as fish, shrimp, mussels, crab, lobster, oyster, clam, octopus and clam may be included. Meat such as beef, pork, lamb, veal, buffalo, venison may be included. Soy products such as tofu may be included as well. The resulting product should be storable at room temperature (room temperature is the normal temperatures found in a home, approximately 70 degrees Fahrenheit but may vary from 50 degrees Fahrenheit to 95 degrees Fahrenheit) for a period of time, perhaps between 18 months and two years. Additionally, the resulting product should have an appealing taste and color and should not include artificial preservatives, thereby allowing the manufacturer to label the product as “natural.”

The mixture may be cooked in a wide range of batch sizes, perhaps mixed in a kettle, perhaps a 150-gallon kettle. The first step is to mix a first set of ingredients such as oil and onion 110 and cook them, perhaps until the onion appears translucent 120. Next, a second set of ingredients is added, perhaps spices, water and tomato components 130. Perhaps there might be a substantial amount of tomato components, including tomato paste and diced tomatoes, for example. Perhaps the percentage of tomato components may range from 20 percent to over 50 percent. A pH stabilizer is added at this step in effective amount so as to lower the pH level of the resulting mixture, after cooking, to somewhere below 4.6. This amount may be between 5 percent and 15 percent of the mixture, perhaps around 10 percent. Note that after cooking, additional cultured dextrose may be added if the pH level of the mixture is not lower than 4.6, preferably between 4.25 and 4.45. The pH stabilizer is a material that reduces the pH and limits growth of yeast and mold. Cultured dextrose is an example of a pH stabilizer and is otherwise known as a propionibacteria metabolite and is available under the brand name MICROGARD®MG-200 from Rhodia, Inc., Cranbury, N.J. These materials are disclosed in U.S. Pat. Nos. 5,096,718 and 5,260,061 and are hereby incorporated by reference. One beneficial aspect of cultured dextrose is that it is a natural ingredient. The amount of cultured dextrose that is added in an amount sufficient to reduce the targeted pH level to around 4.6, thus reducing spoilage. The pH level may be reduced to a range of between 4.25 and 4.45.

Next, the mixture is heated to a temperature approximately between 160 F. and 180 F. and may remain at that temperature for a cooking period (140). Now, the protein ingredient(s) is/are added to the mixture. The protein ingredient(s) may consist of one or more ingredients such as seafood (e.g., fish, tuna, crab, lobster, scallops, clams, shrimp, mussels, crawfish, octopus and squid), meat (e.g., beef, pork, chicken, turkey, duck, venison, wild fowl) and soy-based products (e.g., tofu). At this time, additional ingredients that require less cooking may also be added, perhaps zucchini.

After the protein is added, the mixture cools and must be heated again to a temperature of around 195 degrees Fahrenheit and maintained at that temperature for approximately 15 minutes to kill bacteria 160. Before sealing the product in containers, the final pH level is measured 170 and if it is greater than approximately 4.6 (180), additional quantities of cultured dextrose is added 190, preferably attaining a pH level of between 4.25 and 4.45. Finally, the product is placed in jars and sealed with lids using a Hot Fill process that is known in the industry 195. Although a glass jar with a metal lid that has a rubber seal is preferred, the jar and lid could be made of any suitable material, including plastic, and could be transparent, translucent or opaque. Being that one of the results of the process is to retain the natural tomato color, a transparent or translucent jar may be preferred.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of preparing a food product containing protein comprising:
combining a first set if ingredients into a mixture;
cooking said mixture;
adding a second set of ingredients to said mixture whereas said second set of ingredients includes tomato-based ingredients and an effective amount of pH stabilizer;
continuing to cook said mixture;
combining a third set of ingredients into said mixture, said third set of ingredients including a protein;
further cooking said mixture;
placing said mixture in a plurality of jars; and
sealing said plurality of jars.

2. The method of claim 1 wherein said pH stabilizer is cultured dextrose.

3. The method of claim 1 wherein said pH stabilizer is a propionibacteria metabolites.

4. The method of claim 1 wherein said plurality of jars substantially consists of a material selected from the group consisting of glass and plastic.

5. The method of claim 1 wherein said tomato-based ingredients is selected from the group consisting of tomato puree, diced tomatoes, chopped tomatoes, whole tomatoes, crushed tomatoes and mixtures thereof.

6. The method of claim 1 wherein said step of further cooking further comprises bring said mixture to a temperature of at least 195 degrees Fahrenheit for at least 15 minutes

7. The method of claim 1 wherein said protein is selected from the group consisting of fish, shrimp, clams, mussels, tuna, shark, scallops, lobster, crab, octopus, squid, crawfish and mixtures thereof.

8. The method of claim 7 wherein said protein accounts for more than three percent of said mixture.

9. The method of claim 7 wherein said protein accounts for more than twenty percent of said mixture.

10. The method of claim 1 wherein said protein is selected from the group consisting of beef, pork, chicken, turkey, buffalo, wild game, venison and mixtures thereof.

11. The method of claim 7 wherein said food product is a sauce selected from the group consisting of tomato sauce, pasta sauce, pizza sauce, an appetizer and salsa.

12. The method of claim 1 wherein said mixture is void of artificial preservatives.

13. The method of claim 1 wherein said mixture is stable at room temperature for a period of at least one year.

14. The method of claim 7 further comprising:
after said step of further cooking, measuring the pH level of said mixture and if said pH level is higher than 4.6 adding additional pH stabilizer to reduce said pH level to a level that is less than or equal to 4.6.

15. The method of claim 14 further comprising:
waiting for a period of time before said placing and if said pH is above 4.45, adding additional pH stabilizer to reduce said pH level to a level that is between 4.25 and 4.45.

16. The method of claim 15 wherein said period of time is approximately 48 hours.

17. A method of preparing a tomato-based product containing protein comprising:
combining a first set if ingredients into a mixture;
cooking said mixture;
adding an effective amount of propionibacterial metabolites;
continuing to cook said mixture;
combining a second set of ingredients into said mixture, said second set of ingredients including a protein;
further cooking said mixture;
placing said mixture in a plurality of jars; and
sealing said plurality of jars.

18. The method of claim 15 wherein said propionibacteria metabolites is cultured dextrose.

19. The method of claim 17 wherein said plurality of jars substantially consists of a material selected from the group consisting of glass and plastic.

20. The method of claim 17 wherein said tomato-based ingredients is selected from the group consisting of tomato puree, diced tomatoes, chopped tomatoes, whole tomatoes, crushed tomatoes and mixtures thereof.

21. The method of claim 17 wherein said step of further cooking further comprises bring said mixture to a temperature of at least 195 degrees Fahrenheit for at least 15 minutes

22. The method of claim 17 wherein said protein is selected from the group consisting of fish, shrimp, clams, mussels, tuna, shark, scallops, lobster, crab, octopus, squid, crawfish and mixtures thereof.

23. The method of claim 22 wherein said mixture contains more than three percent protein.

24. The method of claim 22 wherein said mixture contains more than twenty percent protein.

25. The method of claim 17 wherein said protein is selected from the group consisting of beef, pork, chicken, turkey, buffalo, wild game, venison and mixtures thereof.

26. The method of claim 22 wherein said said tomato-based product is a sauce selected from the group consisting of tomato sauce, pasta sauce, pizza sauce, an appetizer and salsa.

27. The method of claim 22 wherein said mixture is void of artificial preservatives.

28. The method of claim 22 further comprising:
measuring the pH level of said mixture and if said pH level is higher than 4.6 adding additional propionibacteria metabolites to reduce said pH level to a level that is less than or equal to 4.6

29. The method of claim 28 wherein said propionibacteria metabolite is cultured dextrose.

30. The method of claim 28 further comprising:
waiting for a period of time before said placing and if said pH is above 4.45, adding additional propionibacteria metabolites to reduce said pH level to a level that is between 4.25 and 4.45.

31. The method of claim 30 wherein said period of time is approximately 48 hours.

32. A food composition comprising substantially natural ingredients having increased resistance against spoilage caused by mold and/or bacteria, having a pH level of less than 4.6 comprising:
at least 25% tomato ingredients;
at least 3% protein; and
an effective amount of propionibacteria metabolites.

33. The food composition of claim 32, wherein said pH level is between 4.25 and 4.45.

34. The food composition of claim 32, wherein said propionibacteria is cultured dextrose.

35. The food composition of claim 34, wherein said protein is selected from the group consisting of fish, shrimp, clams, mussels, tuna, shark, scallops, lobster, crab, octopus, squid, crawfish and mixtures thereof.

36. The food composition of claim 35, wherein the amount of said tomato ingredients is between 35% and 60% by weight of said composition.

37. The food composition of claim 35, wherein the amount of said tomato ingredients is approximately 49% by weight of said composition.

38. The food composition of claim 35, wherein said food composition can be stored at room temperature for at least one year.

39. The food composition of claim 35, wherein said food composition comprises natural ingredients.
